(19) United States
(12) Patent Application Publication
(10) Pub. No.: US 2025/0158430 A1
(43) Pub. Date: May 15, 2025

(54) SELF-RECOVERY MODULE

(71) Applicant: Our Next Energy, Inc., Novi, MI (US)

(72) Inventors: Krzysztof Klesyk, Novi, MI (US); Yingying Gui, Novi, MI (US); Yan Zhou, Novi, MI (US); Richard Hampo, Ann Arbor, MI (US)

(21) Appl. No.: 18/943,835

(22) Filed: Nov. 11, 2024

Related U.S. Application Data
(60) Provisional application No. 63/598,125, filed on Nov. 12, 2023.

(51) Int. Cl. H02J 7/00

(52) U.S. Cl. CPC H02J 7/0031; H02J 7/00304; H02J 2207/20; H02J 2310/48

(57) ABSTRACT

A power supply system including a controller, a high-voltage battery, a low-voltage electric storage device operatively coupled to the high-voltage battery through a positive and a negative contactor, and a self-recovery module that bypasses the positive and negative contactors and is directly and electrically connected to the high-voltage battery. The self-recovery module includes a step-down converter and a charging circuit. The controller is configured to sense a voltage of the low-voltage electric storage device and charge the low-voltage electric storage device via the charging circuit responsive to sensing the voltage to be below a predetermined threshold.

### BACKGROUND

### Technical Field

The present disclosure generally relates to a self-recovery module and more particularly to a self-recovery module connected to a high-voltage battery and used to charge a low-voltage electric storage device by bypassing a pair of high-voltage contactors.

### Description of the Related Art

Battery packs produce electrical energy to provide power to an electrical system, such as an electric vehicle (EV) or an energy storage system (ESS). Electrical systems with high voltages and currents typically include contactors. A contactor is an electromechanical switch that may be used to control high-voltage and high-current circuits in various electrical and industrial applications. Contactors are designed to make or break electrical connections in a circuit, typically in response to a control signal. The voltages provided by a battery pack in an electrical system may be high and thus, contactors may be used to control the flow of high-voltage electrical power within the electrical system, ensuring safety and efficient operation.

### BRIEF SUMMARY

According to an embodiment of the present disclosure, a power supply system is disclosed. The power supply system includes a controller, a high-voltage battery, a low-voltage electric storage device operatively coupled to the high-voltage battery through a positive and a negative contactor, and a self-recovery module that bypasses the positive and negative contactors and is directly and electrically connected to the high-voltage battery. The self-recovery module includes a step-down converter and a charging circuit. The controller is configured to sense a voltage of the low-voltage electric storage device and charge the low-voltage electric storage device via the charging circuit responsive to sensing the voltage to be below a predetermined threshold.

In one embodiment, the low-voltage electric storage device is a 6V, 12V, or 24V SLI (Starting, Lighting, and Ignition) battery.

In one embodiment, the step-down converter is configured to operate in a current mode wherein current is supplied to the charging circuit, and in a voltage mode wherein current is cut off from the charging circuit.

According to an embodiment, a method is disclosed including providing a controller, providing a high-voltage battery, operatively coupling a low-voltage electric storage device to the high-voltage battery through a pair of high-voltage contactors, and directly and electrically connecting a self-recovery module that bypasses the pair of high-voltage contactors to the high-voltage battery. The method further includes sensing, using the controller, a voltage of the low-voltage electric storage device and charging the low-voltage electric storage device, via the charging circuit responsive to sensing that the voltage is below a predetermined threshold.

### BRIEF DESCRIPTION OF THE DRAWINGS

To easily identify the discussion of any particular element or act, the most significant digit or digits in a reference number refer to the figure number in which that element is first introduced.

FIG. 1 depicts a drivetrain and energy storage components in accordance with illustrative embodiments.

FIG. 2 depicts a block diagram of a battery pack in accordance with an illustrative embodiment.

FIG. 3 depicts a block diagram of a power supply system in accordance with an illustrative embodiment.

FIG. 4 depicts a block diagram of a power supply system in accordance with an illustrative embodiment.

FIG. 5 depicts a block diagram of a power supply system in accordance with an illustrative embodiment.

FIG. 6 depicts a flow chart of routine in accordance with an illustrative embodiment.

FIG. 7 depicts a functional block diagram of a computer hardware platform in accordance with illustrative embodiments.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, and/or components have been described at a relatively high level, without detail, to avoid unnecessarily obscuring aspects of the present teachings.

In one aspect, spatially related terminology such as “front,” “back,” “top,” “bottom,” “beneath,” “below,” “lower,” above,” “upper,” “side,” “left,” “right,” and the like, may be used with reference to the orientation of the figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below”, or “beneath” other elements or features would then be oriented “above” the other elements or features. Thus, for example, the term “below” can encompass both an orientation that is above, as well as below. The device may be otherwise oriented (rotated 90 degrees or viewed or referenced at other orientations) and the spatially relative descriptors used herein should be interpreted accordingly.

As used herein, the terms “lateral” and “horizontal” describe an orientation parallel to a first surface of a cell. As used herein, the term “vertical” describes an orientation that is arranged perpendicular to the first surface of a cell.

As used herein, the terms “coupled” and/or “electrically coupled” are not meant to mean that the elements must be directly coupled together—intervening elements may be provided between the “coupled” or “electrically coupled” elements. In contrast, if an element is referred to as being “directly connected” or “directly coupled” to another element, there are no intervening elements present. The term “electrically connected” refers to a low-ohmic electric connection between the elements electrically connected together.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It is to be understood that other embodiments may be used, and structural or logical changes may be made without departing from the spirit and scope defined by the claims. The description of the embodiments is not limiting. In particular, elements of the embodiments described hereinafter may be combined with elements of different embodiments.

For the sake of brevity, conventional techniques related to electric vehicles, power supply systems, battery packs, and their use may or may not be described in detail herein. Moreover, the various tasks and process steps described herein can be incorporated into a more comprehensive procedure or process having additional steps or functionality not described in detail herein.

Turning now to an overview of technologies that generally relate to the present teachings, vehicles may include a low-voltage electric storage device such as a 12V battery that is used for various functions including starting the engine, powering accessories, storing electrical energy, and supporting a charging system. More specifically, the 12V battery may provide the initial electrical power needed to start a driving process. When the ignition key is engaged, the battery may send an electrical current to a starter motor, which turns the engine over and begins a power cycle. Further, the 12V battery may supply power to various electrical accessories and components in the vehicle, including but not limited to, the lights (headlights, taillights, interior lights), radio, power windows, power locks, and climate control systems.

Contactors on the other hand may be used to disconnect a high-voltage (HV) battery pack from the rest of the vehicle's electrical system. This may be beneficial for safety during maintenance, servicing, and in the event of an accident, helping to prevent electrical shock and fires.

The illustrative embodiments, however, recognize that the 12V battery may gradually lose charge over time. After several days of parking, the vehicle may need a jumpstart to recharge the 12V battery and resume normal driving. Unlike conventional gas vehicles, electric vehicles may come with the high-voltage battery which may be utilized to charge a 12V battery by using electric signals provided by energy from the 12V battery to close and open HV contactors. However, even though the 12V battery may be charged when the high-voltage (HV) contactors are closed via a dedicated DC/DC converter between the high-voltage battery and the 12V battery, there may be scenarios in which the voltage of the 12V battery drops to a level where it can't provide enough energy to close the HV contactors. In this case, even if the high-voltage bus is fully charged, the 12V battery may be unchargeable due to an electrical path that cannot be closed.

The illustrative embodiments disclose a self-recovery module that includes a step-down power converter and a charging circuit. The step-down converter is always attached to the high-voltage battery. The charging circuit includes a current limiting component, a low-power sleep mode component, a back-feed and protection circuit and voltage sensing capabilities. The step-down converter operates in at least two modes including a current mode and a voltage mode.

In an illustrative embodiment, the charging circuit monitors the voltage level of the 12V battery. Responsive to a request to charge the 12V battery, the step-down converter works in a current mode. A signal may be sent from a microcontroller to the self-recovery module to adjust the output voltage level of the step-down converter and activate the charging circuit. The self-recovery module may then charge up the 12V battery. In the normal operating case, i.e., a voltage mode, the step-down converter may supply power to a battery management system (BMS) and/or other devices while the charging circuit is in low-power sleep mode and may block back-feeding from the 12V battery. The design may obviate the case where the voltage of the 12V battery is too low to close HV contactors. This may be applicable to other batteries such as a 24V battery.

### Example Vehicle System

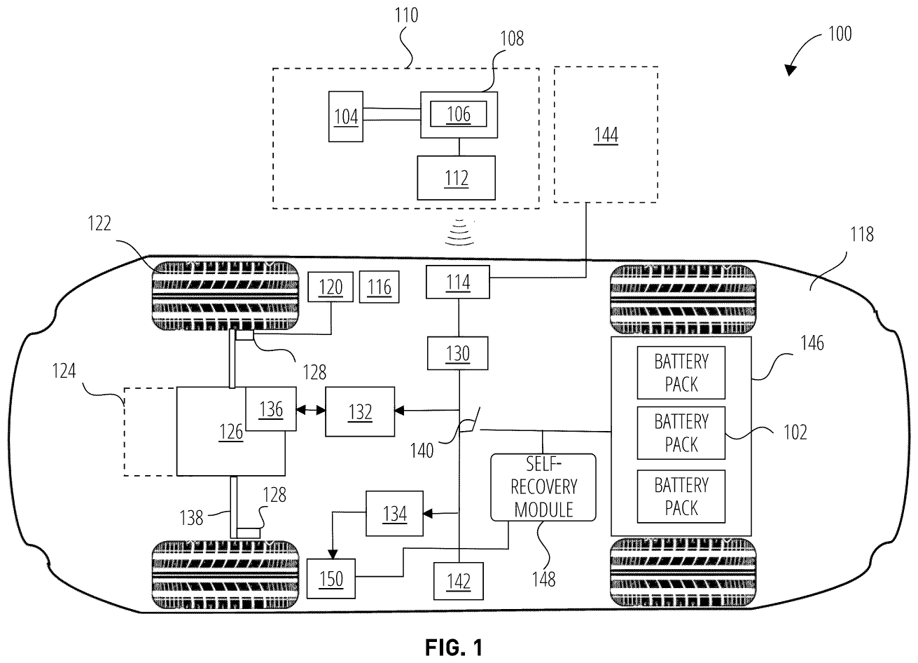

Turning to FIG. 1, a schematic of a generalized electric vehicle system 100 in which battery packs 102 of a high-voltage battery 146 may be housed will be described. It will become apparent to a person skilled in the relevant art(s) that the concepts described herein are directed to battery packs and power supply systems used in all electrified/electric vehicles, including, but not limited to, battery electric vehicles (BEV's), plug-in hybrid electric vehicles, motor vehicles, railed vehicles, watercraft, and aircraft configured to utilize rechargeable electric batteries as their main source of energy to power their drive systems propulsion or that possess an all-electric drivetrain. The concepts may also apply to any other applications in which an energy supply is utilized, such as in a home or commercial energy storage system.

The electric vehicle 118 may comprise one or more electric machines 136 mechanically connected to a transmission 126. The electric machine 136 may be capable of operating as a motor or a generator. In addition, the transmission 126 may be mechanically connected to an engine 124, as in a PHEV. The transmission 126 may also be mechanically connected to a drive shaft 138 that is mechanically connected to the wheels 120. The electric machine 136 can provide propulsion and deceleration capability when the engine 124 is turned on or off. The electric machine 136 also acts as a generator and can provide fuel economy benefits by recovering energy that would normally be lost as heat in the friction braking system. The electric machine 136 may also reduce vehicle emissions by allowing the engine 124 to operate at more efficient speeds and allowing the electric vehicle 118 to be operated in electric mode with the engine 124 off in the case of hybrid electric vehicles.

A battery pack 102 stores energy that can be used by the electric machine 136. The battery pack 102 typically provides a high voltage DC output and may be electrically connected to one or more power electronics modules 132. A battery pack may also include one or more modules each including a plurality of cells. A plurality of battery packs may be configured as a high-voltage battery 146, providing several tens or hundreds of volts as output (e.g., 200V to 800V, or 60V to 800V, or 60 to 2000V, or greater than 60V). A self-recovery module 148 may be directly and electrically connected to the high-voltage battery 146. More specifically, the self-recovery module 148 may be electrically connected to, and physically attached to, the high-voltage battery 146, without the use of an intervening contactor or switch or relay or another controllable connecting device. For example, a low resistance connection such as a low resistance wire or busbar may be part of the high-voltage battery or self-recovery module and may serve as the direct connection between the self-recovery module 148 to the high-voltage battery 146.

Terminals of cells of the battery packs 102 may be tapped through one or more interconnects. One or more high-voltage contactor 140 may further isolate the high-voltage battery 146 and battery packs 102 from other components when opened and connect the battery pack 102 to other components when closed. The battery pack assembly may in some cases be configured to have a cell-to-pack arrangement. For example, a battery pack may include cells directly placed in an enclosure without the use of separate modules, with the enclosure also housing other hardware such as, but not limited to a pre-charge circuit, power electronics module 132, DC/DC converter 134, system controller 116 (such as a battery management system (BMS)), power conversion module 130, battery thermal management system (cooling system and electric heaters) and high-voltage contactor 140.

The power electronics module 132 may also be electrically connected to the electric machine 136 and may provide the ability to bi-directionally transfer energy between the battery pack 102 and the electric machine 136. For example, a traction or range-extender battery may provide a DC voltage while the electric machine 136 may operate using a three-phase AC. The power electronics module 132 may convert the DC voltage to a three-phase AC for use by the electric machine 136. In a regenerative mode, the power electronics module 132 may convert the three-phase AC from the electric machine 136 acting as generators to the DC voltage compatible with the battery pack 102. The description herein is equally applicable to a BEV. For a BEV, the transmission 126 may be a gearbox connected to an electric machine 136 and the engine 124 may not be present.

In addition to providing energy for propulsion, the battery packs 102 may provide energy for other vehicle electrical systems. A typical system may include a DC/DC converter 134 that converts the high-voltage DC output of the battery pack 102 to a low-voltage DC supply that is compatible with other vehicle loads. Other electrical loads 142, such as compressors and electric heaters, may be connected directly to the high-voltage without the use of a DC/DC converter 134. The low-voltage systems may be electrically coupled to the low-voltage electric storage device 150 (e.g., 12V battery).

The battery packs 102 may be recharged by a charging system such as a wireless vehicle charging system 110 or a plug-in charging system 144. The wireless vehicle charging system 110 may include an external power source 104. The external power source 104 may be a connection to an electrical outlet. The external power source 104 may be electrically coupled to electric vehicle supply equipment 108 (EVSE). The electric vehicle supply equipment 108 may provide an EVSE controller 106 to provide circuitry and controls to regulate and manage the transfer of energy between the external power source 104 and the electric vehicle 118. The external power source 104 may provide DC or AC electric power to the electric vehicle supply equipment 108. The electric vehicle supply equipment 108 may be coupled to a transmit coil 112 for wirelessly transferring energy to a receiver 114 of the vehicle 118 (which in the case of a wireless vehicle charging system 110 is a receive coil). The receiver 114 may be electrically coupled to a charger or onboard power conversion module 130. The receiver 114 may be located on an underside of the electric vehicle 118. In the case of a plug-in charging system 144, the receiver 114 may be a plug-in receiver/charge port and may be configured to charge the battery packs 102 upon insertion of a plug-in charger. The power conversion module 130 may condition the power supplied to the receiver 114 to provide the proper voltage and current levels to the battery pack 102. The power conversion module 130 may interface with the electric vehicle supply equipment 108 to coordinate the delivery of power to the electric vehicle 118.

One or more wheel brakes 128 may be provided for decelerating the electric vehicle 118 and preventing motion of the electric vehicle 118. The wheel brakes 128 may be hydraulically actuated, electrically actuated, or some combination thereof. The wheel brakes 128 may be a part of a brake system 120. The brake system 120 may include other components to operate the wheel brakes 128. For simplicity, the figure depicts a single connection between the brake system 120 and one of the wheel brakes 128. A connection between the brake system 120 and the other wheel brakes 126 is implied. The brake system 120 may include a controller to monitor and coordinate the brake system 120. The brake system 120 may monitor the brake components and control the wheel brakes 128 for vehicle deceleration. The brake system 120 may respond to driver commands and may also operate autonomously to implement features such as stability control. The controller of the brake system 120 may implement a method of applying a requested brake force when requested by another controller or sub-function.

### Example Battery Pack

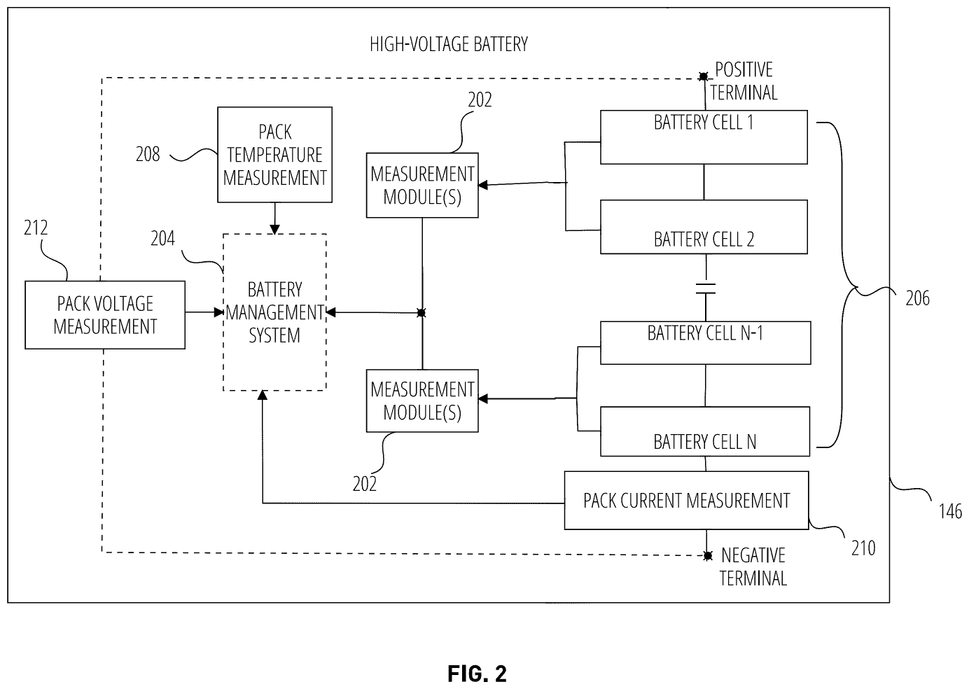

Turning now to FIG. 2, an example battery pack is disclosed to illustrate components thereof. Other battery pack arrangements, however, may be composed of any number of individual cells 206 coupled in series or parallel or some combination thereof. The battery pack 102 may be disposed in power supply systems which also have controllers such as the battery management system (BMS 204) that monitors and controls the performance of the cells 206 of the self-recovery module 148 and/or battery pack 102 as a whole. The BMS 204 may monitor several battery pack level characteristics such as pack current 210, short circuits, pack voltage 212 and pack temperature 208. For example, a voltage measurement apparatus may be used to measure pack voltage. The BMS 204 may have non-volatile memory such that data may be retained when the BMS 204 is in an off condition. Retained data may be available upon the next key cycle. The BMS 204 may alternatively be located outside the battery pack and may be configured to control a plurality of battery packs and their corresponding pre-charge circuits.

In addition to monitoring the pack level characteristics, there may be cell 206 level characteristics and characteristics of the low-voltage electric storage device 150 that are measured and monitored. A system may use a measurement module(s) 202 to measure the combined cell 206 characteristics. Depending on the capabilities, the measurement module(s) 202 may measure the characteristics of one or multiple of the cells 206. Each measurement module(s) 202 may transfer the measurements to the BMS 204 for further processing and coordination. The measurement module(s) 202 may be as simple as one or more switches or leads operated to provide a coupling to the one or more cells. The measurement module(s) 202 may transfer signals in analog or digital form to the BMS 204. In some embodiments, the measurement module(s) 202 functionality may be incorporated internally into the BMS 204. That is, the measurement module(s) 202 comprise hardware that may be integrated as part of the circuitry in the BMS 204 and the BMS 204 may handle the processing of raw signals. Further, the BMS 204 may in some cases be embodied in the form of an electronic measurement device disposed on each of the cells as discussed herein.

It may be useful to calculate various characteristics as well as the configuration of a plurality of battery packs. Quantities such as battery power capability and battery state of charge, battery voltage etc., may be useful for controlling the operation of the battery packs as well as any electrical loads receiving power from the battery packs.

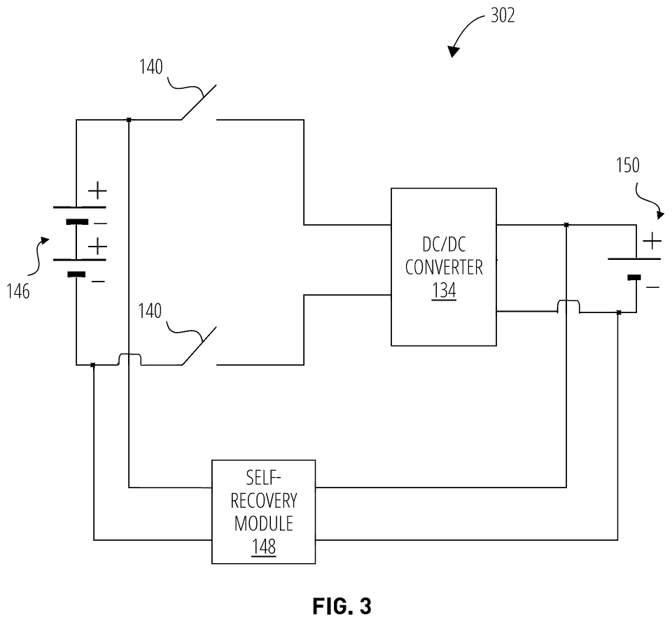

Turning now to FIG. 3, a block diagram of a power supply system 302 is illustrated.

FIG. 3 depicts a block diagram of a power supply system in accordance with an illustrative embodiment. The power supply system 302 comprises a controller such as a BMS 204, a high-voltage battery 146, a low-voltage electric storage device, a pair of high-voltage contactors 140, and a self-recovery module 148.

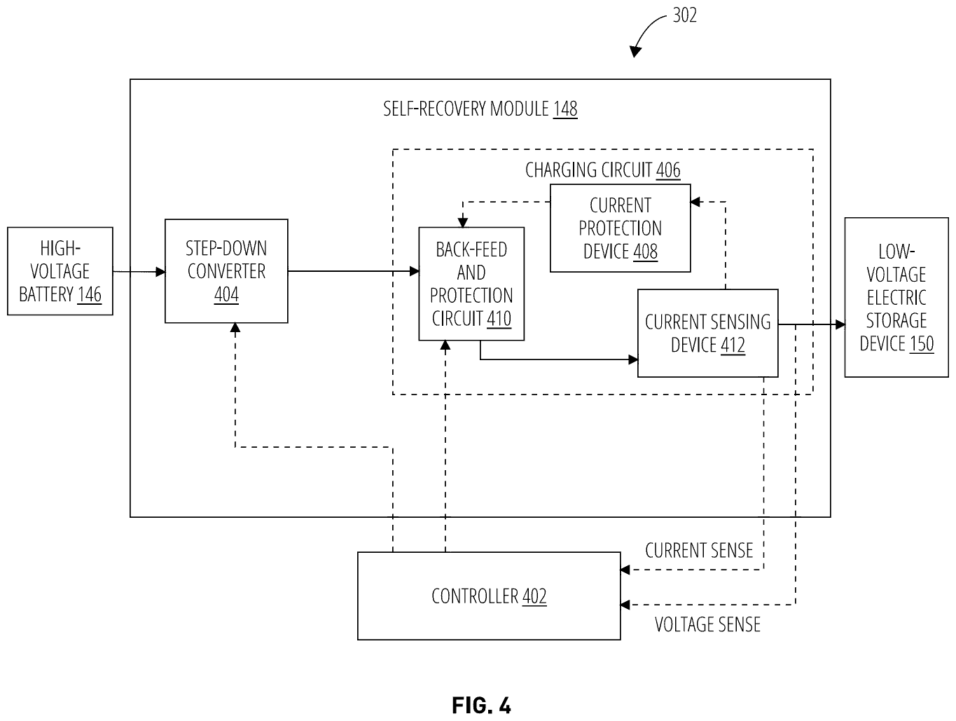

The low-voltage electric storage device 150 may be operatively coupled to the high-voltage battery 146 through the high-voltage contactors 140 (positive and negative high-voltage contactors). The self-recovery module 148 may bypass the high-voltage contactors 140 and be directly and electrically connected to the high-voltage battery 146. The self-recovery module comprises a step-down converter 404 and a charging circuit 406 (See FIG. 4). The step-down converter 404 may be a power converter. A controller may be configured to sense a voltage of the low-voltage electric storage device 150 and to charge the low-voltage electric storage device 150 via the charging circuit 406 responsive to sensing the voltage to be below a predetermined threshold. The predetermined threshold may be based on a voltage of the low-voltage electric storage device below which the high-voltage contactors 140 cannot be closed by energy from the low-voltage electric storage device.

As discussed herein, the low-voltage electric storage device 150 may be utilized to close the high-voltage contactors 140 to then supply power from the high-voltage battery 146 to the low-voltage electric storage device 150 through the DC/DC converter 134. However, when a key of the electric vehicle is on or the power supply system 302 is operational, the voltage of the low-voltage electric storage device 150 may drop to, for example, 6V which may be insufficient for closing the high-voltage contactors 140 when necessary. By adopting a design that bypasses the high-voltage contactors 140 through the use of the self-recovery module 148 the low-voltage electric storage device 150 may be charged without the use of the high-voltage contactors 140.

Apart from serving as a source of power for jump-starting an electric vehicle 118 or other power supply system, the low-voltage electric storage device 150, (such as a 12 V battery or other battery that provides an output voltage below 60V, or below 50V, or below 30V, or below 8V, or between 2-24V) may also provide several important functions such as providing power to various accessories and electrical components in the vehicle, including lights, radio, air conditioning, power windows, and infotainment systems. The low-voltage electric storage device 150 may also supports the vehicle's control systems and computers with modern EVs including complex electronic control units (ECUs) that utilize a stable power source for operations. The low-voltage electric storage device 150 may ensure that these systems remain operational. Further, systems such as airbags, antilock brakes, and stability control that may utilize power even if the main high-voltage traction battery is disconnected or malfunctioning may rely on the low-voltage electric storage device 150. Keyless entry and security, backup power emergency start functions may also be provided by the low-voltage electric storage device 150. More specifically, in the event that the main battery is completely discharged or malfunctioning, the low-voltage electric storage device 150 may be used to start the vehicle's control systems and potentially initiate a “limp mode” to move the vehicle to a service location. Thus, ensuring that the low-voltage electric storage device 150 is always charged may be significantly beneficial to the electric vehicle 118 or power supply system.

FIG. 4 illustrates a block diagram of a power supply system 302 depicting components of the self-recovery module 148 in accordance with an illustrative embodiment.

The self-recovery module 148 may comprise the step-down converter 404 and the charging circuit 406. A controller 402 such as the BMS 204 may be a part of the self-recovery module 148 and disposed inside the self-recovery module 148 such as inside a component of the self-recovery module 148 or may be separate from the self-recovery module 148 and disposed outside the self-recovery module 148. The controller 402 may be configured to continuously or periodically determine the voltage of the low-voltage electric storage device 150 and initiate charging of the low-voltage electric storage device 150 through the charging circuit 406 of the self-recovery module 148. Responsive to the voltage of the low-voltage electric storage device 150 going below a predetermined threshold, the controller 402 may control a back-feed and protection circuit 410 of the charging circuit 406 to draw current from the step-down converter 404 and charge the low-voltage electric storage device 150. The step-down converter 404 may be operated by the controller to be in a current mode at this stage, providing a regulated current to the charging circuit 406. More specifically, the step-down converter 404 is operable in a current mode to regulate current at a desired level and provide the regulated current to the charging circuit 406. The step-down converter 404 is also operable in a voltage mode. Generally, in a voltage mode, the step-down converter 404 provides a constant output voltage as current is drawn therefrom. More specifically, in the voltage mode, the step-down converter 404 maintains a constant output voltage while the charging circuit 406 is disconnected from the step-down converter 404 by disconnecting the back-feed and protection circuit 410 from the step-down converter 404, thereby preventing a current input into the back-feed and protection circuit 410 and charging circuit 406.

During operation of the power supply system 302, a current sensing device 412 may be operable to sense a current being provided to the low-voltage electric storage device 150 to ensure it is in a given range (e.g., 1 A+/−10%, or 10 mA-1.5 A). Responsive to sensing that the current is outside a given range (for example, due to a short circuit), the controller 402 operates the back-feed and protection circuit 410 to shut it off so that current is no longer provided to the low-voltage electric storage device 150. Alternatively, the current protection device 408 may mechanically shut off the back-feed and protection circuit 410 faster based on information from a current sensor. Further, responsive to the controller 402 determining that the low-voltage electric storage device 150 is charged to a predetermined level, the back-feed and protection circuit 410 may be controlled to prevent back-feeding from the low-voltage electric storage device 150. Of course, this configuration is not meant to be limiting as other configurations may be obtained in view of the specification and drawings.

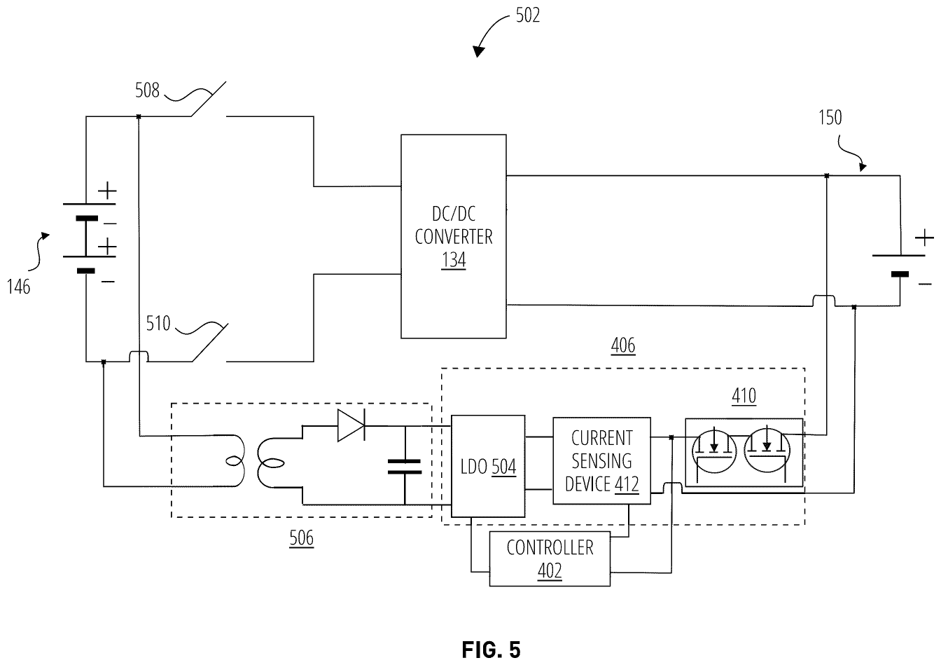

For example, FIG. 5 illustrates an embodiment wherein the back-feed and protection circuit 410 has an alternative disposition. The configuration of FIG. 5 may also comprise a low-dropout regulator 504. The back-feed and protection circuit 410 of FIG. 5 may comprise, for example, two back-to-back Metal Oxide Silicon Field Effect Transistors (MOSFETs), which may work together to block current flow from the low-voltage electric storage device 150 into the charging circuit 406 of FIG. 5 when the charging circuit 406 is in a standby mode. A back feeding channel of the back-feed and protection circuit 410 of FIG. 5 may open when the charging circuit 406 starts charging the low-dropout regulator 504 to allow for current flow from low-dropout regulator 504 to the low-voltage electric storage device 150. Of course, this is not meant to be limiting as other configurations may be possible in view of the descriptions herein.

Generally, the low-dropout regulator 504 provides a regulated output voltage that is powered from a higher voltage input in a variety of applications and may also limit the charging current in case the current capability of the step-down converter is higher than the recovery module needs. The low-dropout regulator 504 may also limit the current.

Further, the step-down converter 404 may be a flyback converter 506 as shown in FIG. 5. The flyback converter 506 bypasses the high-voltage contactor 140 (i.e., the positive high-voltage contactor 508 and the negative high-voltage contactor 510) and is directly and electrically connected to the high-voltage battery 146. The flyback converter 506 is an isolated power converter that provides galvanic isolation between inputs and outputs and may be operated in a current mode and in a voltage mode.

In an operation, when the low-dropout regulator 504 is activated and the flyback converter 506 or step-down converter 404 is in the current mode, the low-dropout regulator 504 receiving the regulated current from the flyback converter 506 may also provide a regulated output voltage that may be coupled to the low-voltage electric storage device 150 responsive to the current sensing device 412 of FIG. 5 sensing that the current satisfies a predetermined threshold condition. The low-dropout regulator 504 may also further regulate the current to a narrower threshold than that provided by the flyback converter 506.

In a further illustrative embodiment, the low-voltage electric storage device 150 is a 12V SLI battery, and the step-down converter 404 is configured to step down the voltage of the high-voltage battery 146 to generate an output voltage that ranges from, for example 10V to 14V. A higher end of the range, for example, a 14V output, may be used when the low-voltage electric storage device 150 is being charged, with the low-dropout regulator 504 regulating the voltage to be in a desired range. The lower end of the range, for example, a 10V output, may be used when the low-voltage electric storage device 150 is not being charged, to provide power to another device. Of course, this is not meant to be limiting as variations thereof may be obtained in view of the descriptions herein. Generally, the controller 402 may monitor the 12 V SLI battery voltage level. Upon determining a desire to charge the 12 V battery, the step-down converter 404 works in a current mode wherein a signal is sent from the controller 402 to the self-recovery module 148 to adjust the output voltage level of the step-down converter 404/power converter and activate on the charging circuit 406. The self-recovery module 148 then charges up the 12 V battery. In the normal operating mode/voltage mode, the step-down converter 404 supplies backup power to the controller 402 or another device (such as a microcontroller, contactor drivers, power management IC, etc.) while the charging circuit 406 is in a low-power sleep mode which may also be configured to block back-feeding from the 12 V SLI battery via the back-feed and protection circuit.

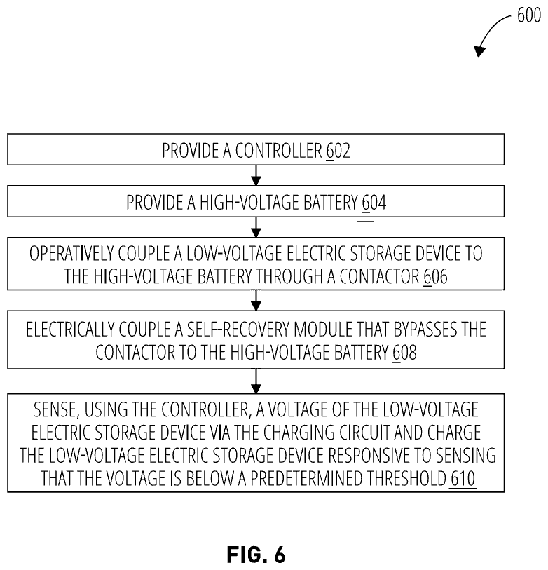

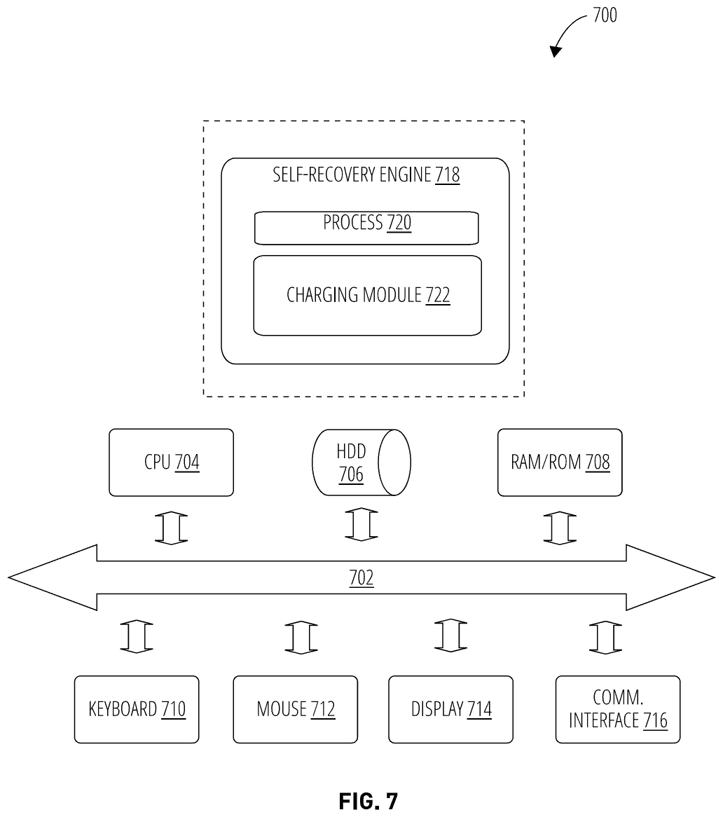

FIG. 6 depicts a self-recovery routine 600 in accordance with illustrative embodiment. The self-recovery routine 600 may be performed with the self-recovery engine 718 of FIG. 7.

In block 602, a controller is provided and in block 604 a high-voltage battery is provided. In block 606 the self-recovery engine 718 may couple a low-voltage electric storage device to the high-voltage battery through a high-voltage contactor that may be selectively toggled on or off using energy provided by the low-voltage electric storage device. In block 608, the self-recovery engine 718 may directly and electrically connect the self-recovery module that bypasses the high-voltage contactor to the high-voltage battery. In block 610, the self-recovery engine 718 may sense, using the controller, a voltage of the low-voltage electric storage device and charge the low-voltage electric storage device responsive to sensing that the voltage is below a predetermined threshold. In some cases, when the charging circuit or self-recovery module is in a sleep mode, the charging circuit or self-recovery module may be configured to wake up from a sleep mode responsive to sensing that the voltage is below a predetermined threshold.

### Example Computer Platform

As discussed above, functions relating to methods and systems for isolation detection can use of one or more computing devices connected for data communication via wireless or wired communication. FIG. 7 is a functional block diagram illustration of a computer hardware platform that can be used to control various aspects of a suitable computing environment in which the process discussed herein can be controlled. While a single computing device is illustrated for simplicity, it will be understood that a combination of additional computing devices, program modules, and/or a combination of hardware and software can be used as well. The computer platform 700 may include a central processing unit (CPU) 704, a hard disk drive (HDD) 706, random access memory (RAM) and/or read-only memory (ROM) 708, a keyboard 710, a mouse 712, a display 714, and a communication interface 716, which are connected to a system bus 702.

In one embodiment, the hard disk drive (HDD) 706, has capabilities that include storing a program that can execute various processes, such as the self-recovery engine 718, in a manner described herein. The self-recovery engine 718 may have various modules configured to perform different functions. For example, there may be a process module 720 configured to control the different routines discussed herein and others. There may be a charging module 722 operable to charge the low-voltage electric storage device via the charging circuit.

For the sake of brevity, conventional techniques related to making and using aspects of the disclosure may or may not be described in detail herein. In particular, various aspects of manufacturing and computing systems and specific programs to implement the various technical features described herein may be well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or system. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram, or the steps (or operations) described therein without departing from the spirit of the disclosure. For instance, the actions can be performed in a differing order or actions can be added, deleted, or modified.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” and similar terms can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A power supply system comprising:
a controller;
a high-voltage battery;
a low-voltage electric storage device operatively coupled to the high-voltage battery through a pair of high-voltage contactors; and
a self-recovery module that bypasses the pair of high-voltage contactors and is directly and electrically connected to the high-voltage battery, the self-recovery module comprising a step-down converter and a charging circuit,
wherein the controller is configured to charge the low-voltage electric storage device via the charging circuit responsive to a voltage of the low-voltage electric storage device being below a predetermined threshold.

2. The power supply system of claim 1, wherein the controller is further configured to sense the voltage of the low-voltage electric storage device.

3. The power supply system of claim 1, wherein the low-voltage electric storage device is a 6V, 12V, or 24V Starting, Lighting, and Ignition (SLI) battery.

4. The power supply system of claim 3, wherein:
the low-voltage electric storage device is a 12V SLI battery, and the step-down converter steps down the voltage of the high-voltage battery to generate an output voltage that ranges from 10V to 14V.

5. The power supply system of claim 1, wherein the low-voltage electric storage device is further operatively coupled to the high-voltage battery through a DC/DC converter.

6. The power supply system of claim 1, wherein the predetermined threshold is based on the voltage of the low-voltage electric storage device below which the pair of high-voltage contactors cannot be closed by the low-voltage electric storage device.

7. The power supply system of claim 1, wherein the step-down converter is a flyback converter.

8. The power supply system of claim 1, further comprising a low-dropout (LDO) regulator coupled to the step-down converter.

9. The power supply system of claim 1, wherein the step-down converter is configured to operate in a first mode in which current is supplied to the charging circuit, and in a second mode in which no current is supplied to the charging circuit.

10. The power supply system of claim 9, wherein, in the second mode:
the step-down converter is further configured to provide power to a battery management system (BMS), and
the charging circuit is configured to be in a sleep mode and to block back-feeding from the low-voltage electric storage device.

11. The power supply system of claim 9, wherein, in the second mode, the step-down converter is further configured to provide power to other devices of the power supply system.

12. The power supply system of claim 9, wherein, in the second mode, a back-feed and protection circuit is controlled to disconnect the charging circuit from the step-down converter.

13. The power supply system of claim 1, wherein a charging current of the charging circuit is 10 mA to 1.5 A.

14. The power supply system of claim 1, wherein the charging circuit comprises a back-feed and protection circuit configured to receive information about a value of a charging current of the charging circuit and to disconnect the charging circuit from the step-down converter responsive to determining that the charging current exceeds another predetermined threshold.

15. The power supply system of claim 14, wherein the charging circuit further comprises a current sensing device and a current protection device configured to be controlled by the controller to sense the value of the charging current.

16. The power supply system of claim 14, wherein the self-recovery module is configured to wake up from a sleep mode responsive to the controller determining that the voltage is below the predetermined threshold.

17. A method comprising:
providing a controller;
providing a high-voltage battery;
operatively coupling a low-voltage electric storage device to the high-voltage battery through a pair of high-voltage contactors; and
directly and electrically connecting a self-recovery module that bypasses the pair of high-voltage contactors to the high-voltage battery, the self-recovery module comprising a step-down converter and a charging circuit,
sensing, using the controller, a voltage of the low-voltage electric storage device, and charging the low-voltage electric storage device, via the charging circuit responsive to sensing that the voltage is below a predetermined threshold.

18. The method of claim 17, wherein the predetermined threshold is based on the voltage of the low-voltage electric storage device below which the high-voltage contactor cannot be closed by the low-voltage electric storage device.

19. The method of claim 17, further comprising:
configuring the step-down converter to operate in a current mode wherein current is supplied to the charging circuit, and in a voltage mode wherein no current is supplied to the charging circuit.

20. The method of claim 19, wherein in the voltage mode:
the step-down converter is further configured to provide power to a battery management system (BMS), and
the charging circuit is configured to be in a sleep mode and to block back-feeding from the low-voltage electric storage device.
